(19) United States
(12) Patent Application Publication
(10) Pub. No.: US 2012/0182150 A1
(43) Pub. Date: Jul. 19, 2012

(54) ACTUATOR HAVING LOAD WEIGHTING MECHANISM

(76) Inventors: Chiung-Yi CHIANG, Taichung City (TW); Ching-Fang Hu, Taichung City (TW)

(21) Appl. No.: 13/009,622

(22) Filed: Jan. 19, 2011

(51) Int. Cl. F16H 19/02; G08B 21/00

(52) U.S. Cl. 340/666; 74/89.23

(57) ABSTRACT

An actuator having a load weighting mechanism is disclosed. The actuator has a screw and a nut mounted around the screw and connected with a driving shaft. The driving shaft supports a load. When moving along the screw, the nut displaces the driving shaft forward and backward. The screw has a pair of thrust bearings for bearing the load, and at least one load weighting unit installed between the pair of thrust bearings for weighting the load.

### BACKGROUND OF THE INVENTION

1. Technical Field

The present invention relates to actuator structure, and more particularly, to an actuator having a load weighting mechanism that measures a load on the actuator and is connected with a controller, which provides overload protection to the actuator.

2. Description of Related Art

With the advanced automation manufacturing technology, linear actuators have become an essential component to automated machines and tool such as beds, chairs, tables, lifting platforms and power-driven windows. Conventional linear actuators are primarily composed of a casing, a motor, a reducer, a screw and a driving shaft, wherein the screw is screwed with a nut that connects with the driving shaft for supporting a load to be controlled. When the motor delivers a rotating force through the reducer to the screw, by virtue of screwing motion between the screw and the nut, the rotating force is transformed into a linear pushing force, so as to displace the driving shaft as well as the load forward and backward.

Conventional actuators are usually made without any load weighting device and therefore need an auxiliary controller to determine whether the actuator is overloaded. However, such a controller providing overload protection by current detection has its effect is subject to various variables, such as the electrical loop, lateral force, friction and circuit configuration, and may fail to realize precise detection and in turn the desired overload protection. Furthermore, the power-driven controller may fail to work once there is no supply of electric power actuator, thus bringing risk to users and the machine itself.

### SUMMARY OF THE INVENTION

The disadvantage of prior-art actuators mainly is lacking of a load weighting device, thus making the actuators unable to detect the load weight and lack for overload protection unless the actuators are supplied with electric power. Whenever the power is disconnected, the overload protection fails, thus leaving the actuators in risk of overload. For overcoming the said disadvantage, the present invention offers an actuator having a load weighting mechanism.

The present invention provides an actuator having a screw and a nut mounted around the screw and connected with a driving shaft for supporting a load, thus allowing the nut moving along the screw to displace the driving shaft forward and backward, wherein the screw is characterized in having a pair of thrust bearings axially installed at one end of the screw for bearing the load, and at least one load weighting unit set between the pair of thrust bearings for weighting the load.

The most important objective of the present invention is to offer the actuator having the load weighting unit provided between the pair of thrust bearings, and the load weighting unit activates and detects the load precisely and spontaneously protects the actuator from overloading despite the actuator stays still or operates.

The other objective of the present invention is to offer the actuator with a controller that is electrically connecting with a buzzer generating an audio warning under the control of the controller for alerting a user to stop or pause the operation of the actuator, thus enhancing safety during the operation of the actuator.

The other objective of the present invention is to offer the actuator with the load weighting unit that is capable of detecting and measuring a load weight, and further protecting the actuator from overloading.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is an applied view of one embodiment of an actuator having a load weighting mechanism in the present invention;

FIG. 2 is an exploded view of the load weighting mechanism in the present invention;

FIG. 3 is a partial cross-sectional view of the load weighting mechanism in the present invention when the screw is pushed toward a first thrust bearing, so that the first thrust bearing pushes toward a second thrust bearing; and

FIG. 4 is a partial cross-sectional view of the load weighting mechanism in the present invention when the screw rotates toward the first thrust bearing, so that the first thrust bearing pushes toward the second thrust bearing.

### DETAILED DESCRIPTION OF THE PREFERRED EMBODIMENT

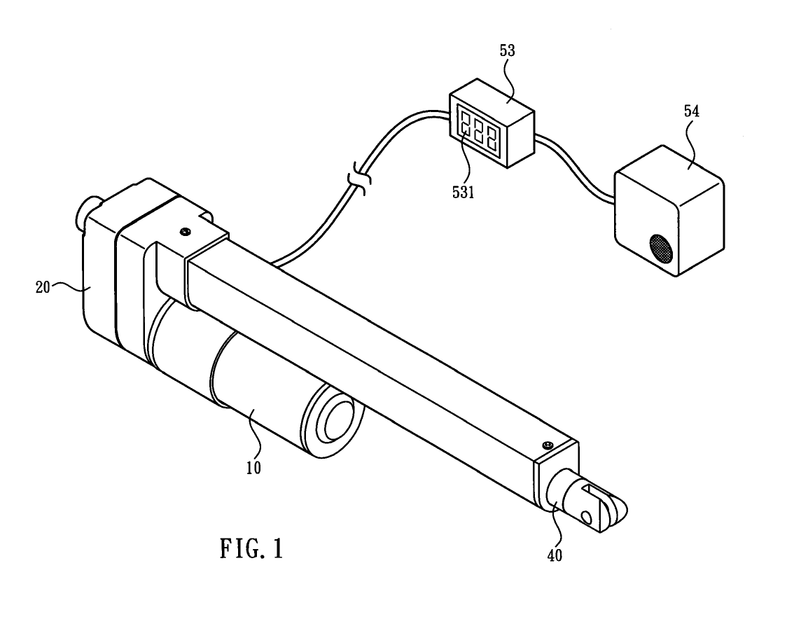

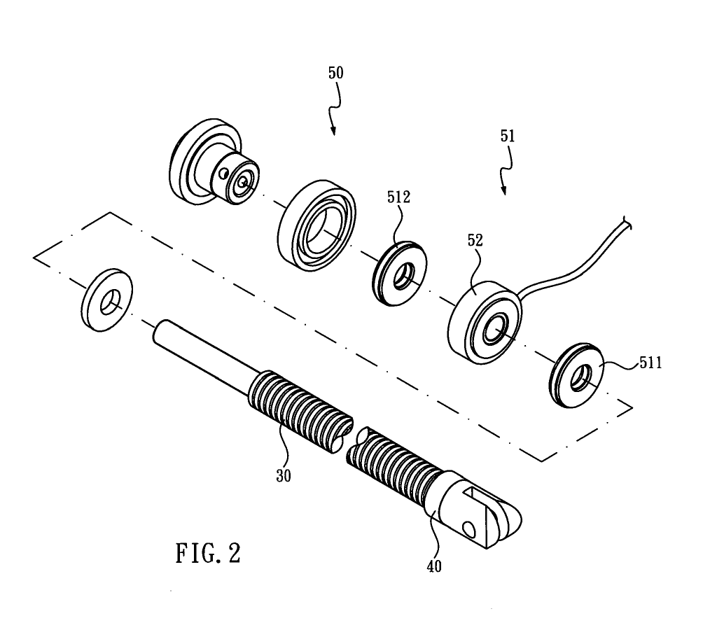

As shown in FIG. 1 through FIG. 3, the present invention involves an actuator having a load weighting mechanism, comprising a motor 10, a reducer 20, a screw 30 and a driving shaft 40. The present invention provides the actuator equipped with the load weighting mechanism that provides overload protection to the actuator by virtue of delivering through the motor 10 a rotating force to the reducer 20 for driving the screw 30, so as to displace the driving shaft 40 forward and backward, wherein the screw 30 connects with a load weighting device 50 for detecting a load weight supported by the actuator.

The screw 30 is mounted around by a nut 31 that contacts the driving shaft 40 supporting a load. When the motor 10 drives the screw 30 to rotate, the screw 30 is screwing with the nut 31 to displace the nut 31 along the screw 30. Therefore, the rotating force from the screw 30 has transformed into a linear pushing force to shift the driving shaft 40 forward or backward.

The load weighting device 50 has a pair of thrust bearings 51 including a first thrust bearing 511 and a second thrust bearing 512, the pair of thrust bearings 51 axially provided at one end of the screw 30 away from the driving shaft 40, wherein the first thrust bearing 511 is installed at the other end of the screw 30 near the driving shaft 40 and the second thrust bearing 512 is installed near the reducer 20; a load weighting unit 52 set between the first thrust bearing 511 and the second thrust bearing 512, the load weighting unit 52 which can be a weight sensor for measuring a load weight and electrically connects to a controller 53 for receiving a detecting signal from the load weighting unit 52; and the controller 53 coupled with a displayer 531 for indicating the load weight, the controller 53 electrically connected with a buzzer 54 that generates an audio warning under the control of the controller 53.

Above description is about the structural features of the present invention; the following context illustrates how the actuator works under such structural features.

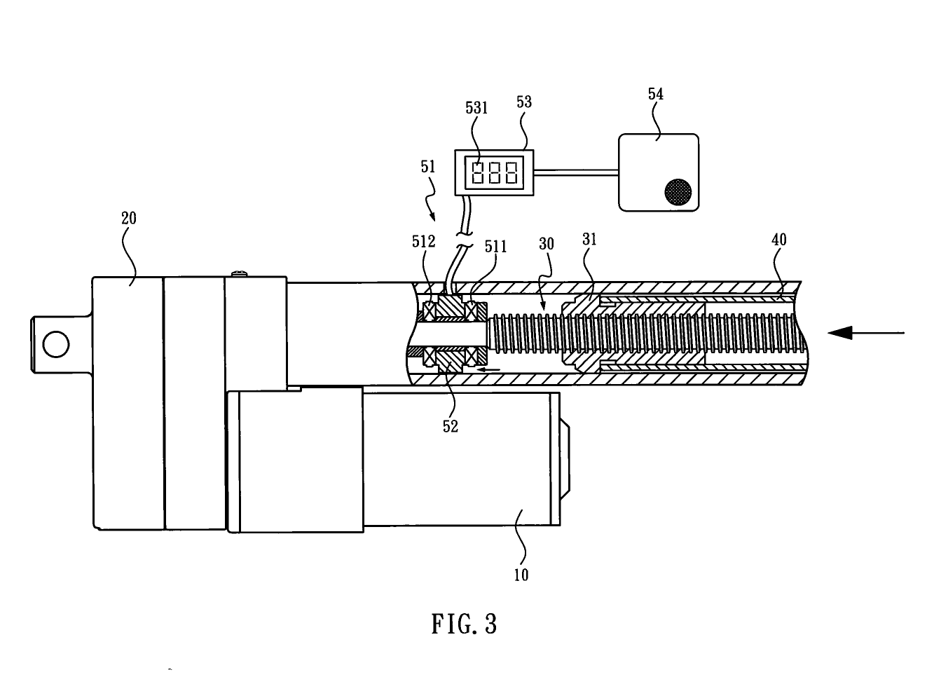

As shown in FIG. 3, when the actuator stays still and the driving shaft 40 is in support of the load, the driving shaft 40 delivers the load through the nut 31 to screw 30, so as to make the first thrust bearing 511 bear the load. At then, a constricting force occurs between the first thrust bearing 511 and the second thrust bearing 512 so that the load weighting unit 52 detects and measures the load weight and generates a detecting signal to the controller 53, thus the load weight is indicated on the displayer 531 for a user's reading.

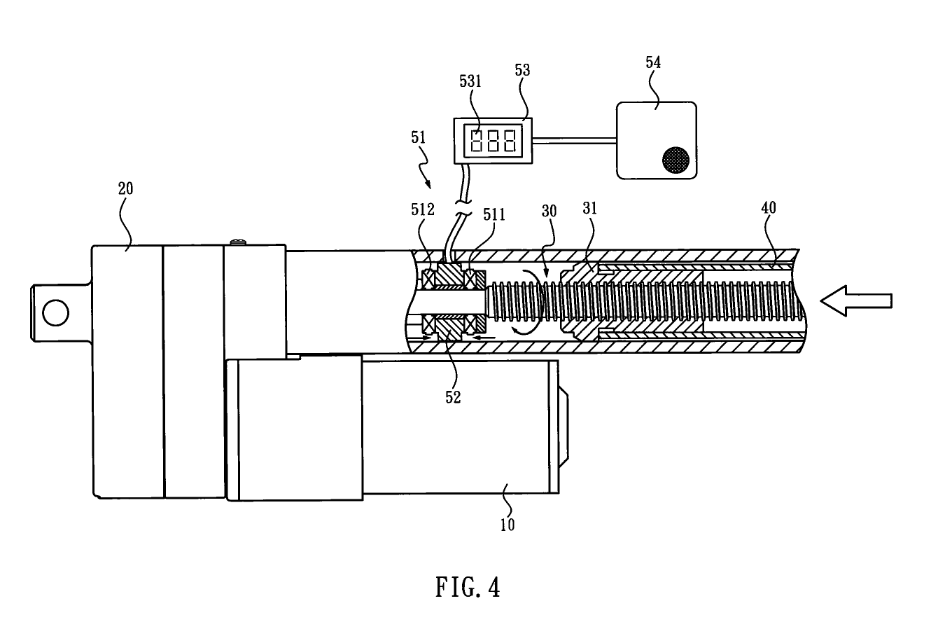

As shown in FIG. 4, when the actuator operates, the screw 30 is driven by the motor 10 to rotate and displace the nut 31 along the screw 30 forward and backward so as to expand or contract the driving shaft 40 while the second thrust bearing 512 generates a pushing force toward the load weighting unit 52 due to the rotation of the screw 30. In the meantime, the driving shaft 40 transmits the load through the nut 31 to the screw 30, so that the first thrust bearing 511 bears the load and pushes toward the load weighting unit 52, thus allowing the load weighting unit 52 to detect and measure the load weight by virtue of the friction torque formed between the first thrust bearing 511 and the second thrust bearing 512, and to indicate the load weight on the displayer 531. When the load weight detected from the load weighting unit 52 shows an overload, the controller 53 controls the buzzer 54 to send out an audio warning for alerting the user to stop or pause the operation of the actuator. Therefore, the load weighting device 50 can detect and measure the load weight supported by the actuator regardless the actuator stays still or during operation, and send out the warning signal when the actuator is overloaded. Therefore, the present invention is effective in preventing the actuator from overloading, and thus enhancing the safety of the actuator during the operation.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention rather than limit the scope of the present invention. Accordingly, the foregoing description and drawings are by way of example only.

What is claimed is:

1. An actuator having a load weighting mechanism, comprising a screw and a nut mounted around the screw and connected with a driving shaft, the driving shaft supporting a load, so that when the nut moving along the screw displaces the driving shaft forward and backward, and the screw being characterized in having:
a pair of thrust bearings for bearing the load; and
at least one load weighting unit installed between the pair of thrust bearings.

2. The actuator of claim 1, wherein the pair of thrust bearings contains a first thrust bearing and a second thrust bearing, and the pair of thrust bearings is provided at one end of the screw away from the driving shaft.

3. The actuator of claim 1, wherein the load weighting unit is electrically connected with a controller.

4. The actuator of claim 3, wherein the controller is coupled with a displayer.

5. The actuator of claim 3, wherein the controller is electrically connected with a buzzer and drives the buzzer to generate an audio warning.
